(19) United States
(12) Patent Application Publication
(10) Pub. No.: US 2006/0265308 A1
(43) Pub. Date: Nov. 23, 2006

(54) System and method for paperless bid management

(76) Inventor: Geoffrey M. Jennings, Austin, TX (US)

Correspondence Address: MATTHEW E. BURR;LAKE AUSTIN MARINA, 2219 WESTLAKE DR, STE 200, AUSTIN, TX, 78746, US

(21) Appl. No.: 11/131,932

(22) Filed: May 18, 2005

(51) Int. Cl. G06Q 40/00

(52) U.S. Cl. 705/37

(57) ABSTRACT

Servers connected to the World Wide Web serve website account pages to the computers of system participants. The system is organized around two classes of participants: buyers and suppliers. Each buyer maintains an account, including website folders and subfolders, at the Website at which she can post to a Web page in the site the specifications and particulars of a project. Each supplier, likewise, maintains an account at the Website at which he can post to a Web page all, or a select portion, of the goods and services that supplier provides. Buyers inspect the company information of suppliers with whom the Buyer has an existing or purchased relationship, to identify suppliers of the goods or services required for the project. When a buyer identifies a relevant supplier, the buyer privately invites one or more supplier to bid on the project. Each supplier evaluates the project and bid request and responds to the invitation by privately submitting a bid to the buyer. The buyer evaluates the bids and selects or declines a bid from one or more supplier.

### FIELD OF THE INVENTION

The present invention relates to the internet, and particularly to systems and methods for managing information exchange over the internet between suppliers and buyers in a contract bid process.

### BACKGROUND OF THE INVENTION

Buyers, including general contractors and subcontractors, in need of goods and services often spend considerable time locating a suitable supplier. Buyers use trade publications, directories, recommendations, personal referrals and other means to locate suppliers. If the type of supplier needed is in a foreign country, the problem of locating the supplier is even more difficult. Suppliers advertise through various media and by direct sales methods to make known to potential buyers what they sell and how to contact them.

Once a buyer identifies some suppliers, each supplier must be contacted to obtain product or service, price and availability information. This is a time consuming, labor intensive process. Companies often rely on experienced, professional, purchasing staff to perform purchasing and bid management.

In a bid context, the process of describing and publicizing a project to buyers and suppliers, and evaluating bids, is similarly complex and is often the domain of expert bid managers. There is no suitable online mechanism by which a buyer may describe the parameters and specifications of a project for a supplier to inspect.

In a conventional on-line shopping system using a personal computer-based communication network or the like, a service-offering side (or merchandise-selling side) supplies merchandise information in response to a merchandise search request.

Users buy a variety of merchandise at a considerable frequency through on-line shopping. Several patents are illustrative of known technology for enabling a user to acquire goods or services while operating on-line. U.S. Pat. No. 4,984,155, for example, issued on Jan. 8, 1991 to Raymond R. Geier et al., describes a system for enabling a customer to operate a data terminal for placing an order for goods or services from a supplier, the data terminal displays information about the goods or services being ordered to complete, correct or update information available from the supplier's catalog.

U.S. Pat. No. 5,136,501, issued on Aug. 4, 1992 to David L. Silverman et al., describes a matching system for trading instruments in which bids are automatically matched against offers for given trading instruments for automatically providing matching transactions in order to complete trades for the given trading instruments, includes a host computer means comprising means for anonymously matching active bids and offers in the system by trading instrument based on a variable matching criteria, which comprises a counterpart credit limit between counterparts to a potential matching transaction.

U.S. Pat. No. 5,351,186, issued on Sep. 27, 1994 to Wayne J. Bullock et al. describes a system and method for obtaining information concerning a product or a service to a user which includes a remotely located source of computer-based information for generating and transmitting encoded data, including encoded audio data, pertaining to a plurality of products or services.

U.S. Pat. No. 5,493,490, issued on Feb. 20, 1996 to Jerome D. Johnson, describes an electronic system for creating customized product proposals that stores a plurality of pictures and text segments to be used as building blocks in creating the proposal.

U.S. Pat. No. 5,664,115, issued on Sep. 2, 1997 to Richard Fraser, describes a method and apparatus for automatically matching sellers of property with potential buyers through a communications network (preferably the Internet) in which a host system communicates with the sellers and the potential buyers over telephone or dedicated data transmission lines.

U.S. Pat. No. 5,758,328, issued on May 26, 1998 to Joseph Giovannoli, describes a computer system forming a computer based communications network of network members inclusive of network buyers and or network suppliers for processing requests for quotation for goods and services through at least one central processing unit including operating system software for controlling the identification of network members, means for network buyers to generate request for quotation for goods and/or services, means for transmitting said request for quotation to said central processing unit, filter means for selecting appropriate network members to receive said request for quotation based on filter conditions defined by the buyer in said request for quotation and/or by the supplier and/or by the central processing unit, means for broadcasting said request for quotation to the network members selected by said filter means and means for responding to the generator of said request quotation with either a response to said, request for quotation or with a list of said selected network members. Filter conditions may define the class of suppliers in terms of geographical location, quantity, language spoken, currency, special conditions of sale, and the like.

U.S. Pat. No. 5,790,426, issued on Aug. 4, 1998 to Gary B. Robinson, describes an automated collaborative filtering (ACF) system for recommending at least one item to a first user based on similarity in preference of the user as compared with other users. The ACF system stores rating data for items provided by users of the system.

U.S. Pat. No. 5,794,212, issued on Aug. 11, 1998 to Alfred F. Mistr, Jr., describes a method for providing more efficient communication between energy suppliers, energy purchasers, and transportation providers and having an administrator to assist in the transmission of energy as necessary for providing timely movement of energy as necessary for providing timely movement of energy.

U.S. Pat. No. 5,832,459, issued on Nov. 3, 1998 to Paul Scott Cameron et al., describes a computerized source searching system and method for the placement of an order for at least one offer via a terminal having a display.

U.S. Pat. No. 5,842,178, issued on Nov. 24, 1998 to Joseph Giovannoli, describes a computerized system for forming a computer based communications network of network members inclusive of network buyers and or network suppliers for processing request for quotation for goods and services through at least one central processing unit including operating system software for controlling the central processing unit, storage means containing the identification of network members, means for network buyers to generate request for quotation for goods and/or services, means for transmitting said request for quotation to said central processing unit, filter means for selecting appropriate network members to receive said request for quotation based on filter conditions defined by the buyer in said request for quotation and/or by the supplier and/or by the central processing unit, means for broadcasting said request for quotation to the network members selected by said filter means and means for responding to the generator of said request for quotation with either a response to said request for quotation or with a list of said selected network members. Filter condition may define the class of suppliers in terms, of geographical location, quantity, language spoken, currency, special conditions of sale, and the like.

U.S. Pat. No. 5,862,223, issued on Jan. 19, 1999 to Jay S. Walker et al. describes an expert matching method and apparatus for managing communications between an expert having particular qualifications and an end user seeking a solution to an expert request.

None of the aforementioned inventions, however, either singly or in combination, describe a method and system for the management of invitation-based online bids. Furthermore, all the above inventions relate to open market e-commerce solutions and do not address solutions to closed or invitation-based e-commerce.

None of the above inventions and patents, taken either singularly or in combination, is seen to describe the instant invention as claimed. Thus, a system and method for data management solving the aforementioned problems is desired.

### BRIEF DESCRIPTION OF THE DRAWINGS

The present invention is further described in the detailed description that follows, by reference to the noted drawings, by way of non-limiting examples of embodiments of the present invention, in which reference numerals represent the same parts throughout the several views of the drawings, and in which:

FIG. 1 is schematic flow chart of a system of the present invention.

FIG. 2 is a computer monitor screen shot of a Buyer Dashboard Webpage of a specific exemplary embodiment of the present invention.

FIG. 3 is a screen shot of a Project s—Buyer Webpage of a specific exemplary embodiment of the present invention.

FIG. 4 is a screen shot of a Buyer Directory Webpage of a specific exemplary embodiment of the present invention.

FIG. 5 is a screen shot of a Bid Mail—Buyer Webpage of a specific exemplary embodiment of the present invention.

FIG. 6 is a screen shot of a My Account—Buyer Webpage of a specific exemplary embodiment of the present invention.

FIG. 7 is a screen shot of a Supplier Dashboard Webpage of a specific exemplary embodiment of the present invention.

FIG. 8 is a screen shot of a Supplier Projects Webpage of a specific exemplary embodiment of the present invention.

FIG. 9 is a screen shot of a Supplier Directory Webpage of a specific exemplary embodiment of the present invention.

FIG. 10 is a screen shot of a Bid Mail—Supplier Webpage of a specific exemplary embodiment of the present invention.

FIG. 11 is a screen shot of a My Account—Suppler Webpage of a specific exemplary embodiment of the present invention.

### DETAILED DESCRIPTION OF THE INVENTION

In view of the foregoing, the present invention, through one or more of its various aspects, embodiments and/or specific features or sub-components, is thus intended to bring out one or more of the advantages that will be evident from the description. The present invention is described with frequent reference to the World Wide Web (the “Web”). It is understood, however, that the Web is merely an example of a specific embodiment of the present invention, which is directed broadly to networked electronic information management, within the scope of the invention. The terminology, examples, drawings and embodiments, therefore, are not intended to limit the scope of the invention.

Managing the bid process for a project, such as a construction project, is complicated. A great deal of paper work must be continually tracked and frequently updated. Changes in the scope or specifications of a project require that each bidder be notified independently and that revised bids are properly correlated to the corresponding revised project.

Managing the paper work alone often means hiring a professional staff of administrators and allocating expensive office space to file cabinets. The overhead demanded by the process is often so great that some contractors limit the number and scope of projects on which they participate to keep their overhead affordable. The present invention employs the advantages of the World Wide Web to manage the bid process in a manner that greatly reduces the overhead for bid projects.

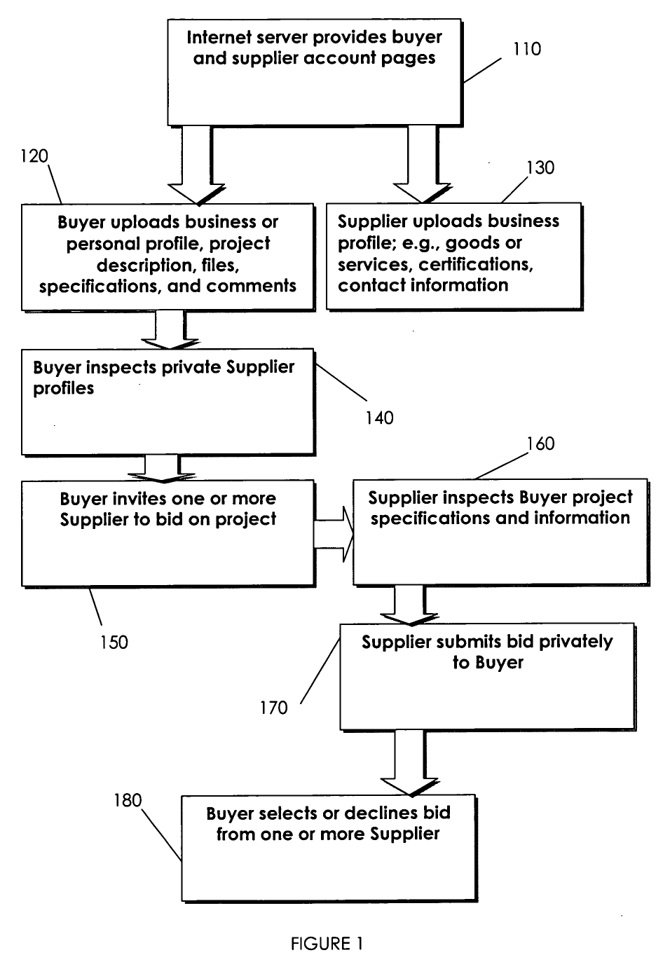

FIG. 1 is schematic flow chart of a system of the present invention. Servers connected to the World Wide Web serve website account pages to the computers of system participants 110. The system is organized around two classes of participants: buyers and suppliers. Each buyer maintains an account, including website folders and subfolders, at the Website at which she can post to a Web page in the site the specifications and particulars of a project 120. Each supplier, likewise, maintains an account at the Website at which he can post to a Web page all, or a select portion, of the goods and services that supplier provides 130.

Buyers are able to inspect the company information 140 of suppliers with whom the Buyer has an existing or purchased relationship, to identify suppliers of the goods or services required for the project. When a buyer identifies a relevant supplier, the buyer privately invites one or more supplier to bid on the project 150. Each supplier evaluates the project and bid request 160 and responds to the invitation by privately submitting a bid to the buyer 170. The buyer evaluates the bids and selects or declines a bid from one or more supplier 180.

A Website of the present invention is broken down into four divisions:
Division 1: General HTML Website pages for Marketing Only;
Division 2: E-Commerce Store for project item purchases;
Division 3: Buyer program pages to post projects and review bids; and
Division 4: Supplier program pages to review projects and post bids.

The Website program pages contemplate a total of five screens:
1) User Dashboard;
2) User Projects;
3) Directory;
4) Bid Mail; and
5) My Account

Each screen is a reporting base screen with editable pop up windows for each internal screen table. It should be noted that some of the windows or screens are described herein for the purpose of illustrative example as “.asp” (active server pages), it will be understood by those skilled in the art, however, that other web development tools are also suitable for the same purposes, including in particular the languages supported by the “.net” framework such visual basic.net and C#.

A document will go into each screen first as a buyer role then second as a supplier role. Each screen request explains the roles of each page including the reporting items, the editable window functions, and the current script location that is found in the electronic document folder, e.g., “Paperless Bid Website.”

A document starts out with the header screen type requests for each Website section. The second item is the menu bar under the program. As for the current Website FTP folder, only three areas need attention.

The main root directory holds the information of home, services, about us, bid cart, and contact us with login, logout, and the like. For example, /inc is a functions folder. /members is the main folder for all .ASP or .NET, for example, pages that are for user editing and bolting to a new Web page.

Buyer Websites contain the following links, for example:
Dashboard—to link to buyer dashboard page
Projects—to link to buyer project list page
Directory—to link to supplier search and report page
Bid Mail—to link to Buyer Bid Mail page
My Account—to link to Buyer account page
Logout—to go to logout page with five second delay to return to home page of Website.

Supplier Websites contain the following exemplary links:
Dashboad—to link to supplier dashboard page
Projects—to link to supplier project list page
Directory—to link to Buyer search and report page
Bid Mail—to link to Supplier Bid Mail page
My Account—to link to Supplier account page
Logout—to go to logout page with five second delay to return to home page of Website.

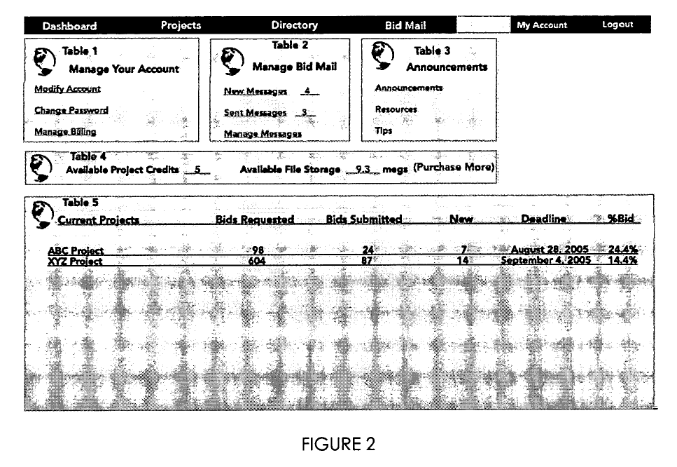

FIG. 2 is a computer monitor screen shot of a Buyer Dashboard Webpage of a specific exemplary embodiment of the present invention. The Webpage displays 5 tables as described below.

Table 1—Manage Your Account

Modify Account provides a link to the My Account page.

Change Password—a pop up window to change and verify new password.

Manage Billing allows a user to go to the My Account page.

Table 2—Manage Bid Mail

Table 2 allows a buyer to see new messages, previously sent messages, or to go to the general screen through Manage Messages. All go to the Bid Mail related sections.

Table 3—Announcements

Table 3 contains links to Announcements, which are general announcements pertaining to the bid management company. It is a link to a new page, e.g., /announcements.html.

Resources displays a new page that is for general bid resource files through a link, e.g., /resources.html (new). Tips displays a pop up window with general bid uploading file management tips, e.g., /tips.asp.

Table 4—Available Projects and Storage

Table 4 provides available projects links to the database and lets the Buyer know how many more projects they have left based upon pre-purchased amounts. The available megs is the amount of storage memory left of pre-purchased file storage and is linked to the database. “Purchase More” is a link to the Bid Cart to purchase more projects or storage credits.

Table 5—Projects

Table 5 is linked to a database that shows all Buyer projects and the current status of each. Each project is a link to the project page for the project selected in the list. The Buyer can select other projects in the same project screen to which the buyer was redirected. In specific embodiments, the individual projects have a scroll over color change function so that the buyer knows which project they are selecting. Alternative embodiments provide other selection indicia known to those in the art, such as highlighting, font bolding, underlining and so forth, to indicate the selected field. This is generally true for the selection indicia described herein.

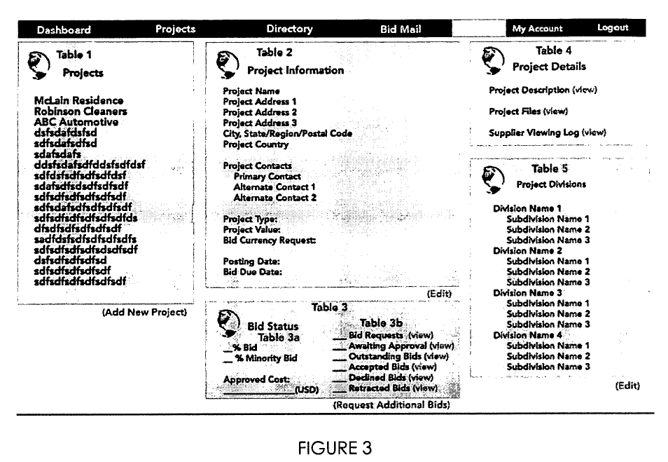

FIG. 3 is a screen shot of a Project s—Buyer Webpage of a specific exemplary embodiment of the present invention. The page of FIG. 3 is broken down into five reporting tables:
Table 1—Project List
Table 2—Project Information
Table 3—Project Bid Status
Table 4—Project Details
Table 5—Project Divisions
Table 1—Project List

The project list is an expanding box vertically that lists all projects that the buyer currently has open in the program. Preferably, the list reports the project names in alphabetically order and accommodates long project names.

The buyer can click on any of the project names and then to the right, the project tables 2-5 appear with the relevant information. As the buyer scrolls over the project names, the color of the name changes to the selected project. At the bottom of table 1 is an “Add New Projects” field. This item is clicked on and opens a new window stream that configures a new project. Once the buyer clicks on the “Add New Project” button, a series of windows is presented to the buyer.

Window one—Project information screen that completes Table 2.

Window two—Project Description screen to fill out description box.

Window three—Project Files screen to upload project files.

Window four—Project Divisions screen to select project type and divisions.

Table 2—Project Information.

The project information table provides all reporting information for the relevant project:
Project Name
Project Address 1
Project Address 2
Project Address 3
City, State/Region, Postal Code
Country
Primary Contact
Email address (hyper link into bid mail center)
Alternate Contact 1
Email address (hyper link into bid mail center)
Alternate Contact 2
Email address (hyper link into bid mail center)
Project Type
Project Posting Date
Project Bid Due Date
Estimated Value.

Table 3—Project Bid Status.

Table is 3 broken down into tables “a” and “b.”

Table A provides the calculated “% Bid”, “% Minority Bid”, and “Accepted Bids Project Cost.” Table B—provides the current numbers of each type of bid status:
Requested Bids
Awaiting Approval
Outstanding
Accepted
Declined
Retracted

Each bid status is a “view” button to the side that creates a pop up window to view the referenced list. At the bottom, Table 3 allows the buyer to “Request Additional Bids”. This is a pop up window that shows all of the selected divisions and all suppliers that are associated with each subdivision. The buyer can at that time select additional suppliers for any new or existing divisions/subdivisions in the project.

Table 4—Project Details.

This table has three components in it:

Project Description—a pop up window that shows the project description box. The buyer may edit the description in this window.

Project Files—a pop up window that shows the current project files. the buyer can Edit the project file list in this window with a current delete button per file or a new pop up window for the new files.

Supplier Viewing Log—a pop up window that shows the viewing history of all suppliers.

Table 5—Project Divisions/Subdivisions.

Table 5 shows all selected divisions for the project. If the buyer wants to edit the division list, then at the bottom of the table is an “Edit” button that has a pop up window that gives the buyer the opportunity to add new divisions and subdivisions to the project from a master list. In particular embodiments of the invention, the buyer can delete an existing subdivision item only if there are no existing bids for that subdivision.

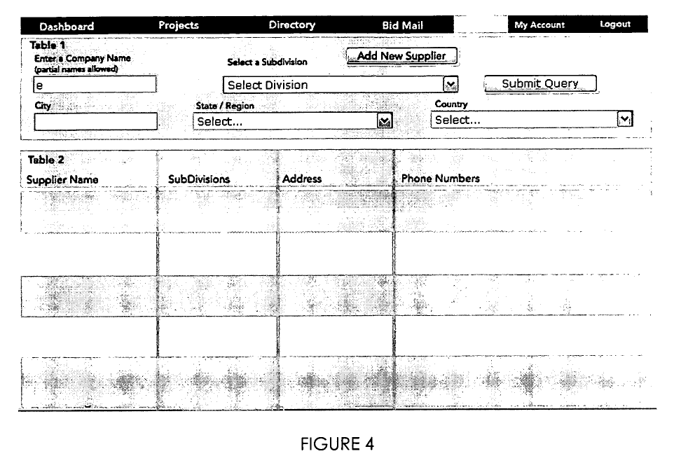

FIG. 4 is a screen shot of a Buyer Directory Webpage of a specific exemplary embodiment of the present invention. The Buyer Directory allows for buyers to search for their current supplier list by searching based upon the criteria of 1) Company Name; 2) Subdivision Handled; 3) City; 4) State/Region; or 5) Country.

Table 1—Query Search Based Upon Above Criteria.

A Buyer can also upload a new supplier to the Website by clicking “Add New Supplier” Button. This will lead the buyer to two pop up windows: 1) enter email address; 2) enter company information.

The first screen verifies if the email is in the database and if so, the supplier information is autopopulated into the buyer's supplier list, or, if the supplier email is not recognized, then the buyer will be sent to screen two to enter the company information.

Table 2—Query Search Results.

Once a buyer has done a query search for the suppliers, the invention populates the list below the query box. In specific embodiments, each supplier is separated some suitable distinguishing indicia such as different colors, alternating colors, highlighting, underlining or the like. The results list the supplier name, address, subdivision, and the phone numbers. The buyer can click on any supplier and a pop up window of the supplier's detail information is displayed.

The Supplier's Detail information includes:
Company name
Company Address
Company Address 2
Company Address 3
City, State/Region, Postal Code
Country
Contacts Primary, Alt. 1 and 2 with all email addresses that hyperlink to the Bid Mail Center
Phone Numbers
Company Website
Company Description Box
Company Certifications
Company Active Sub Divisions
Company Rating—If a buyer would like to rate a supplier, she can click on the rate supplier button. This takes the buyer to a pop up screen to rate four criteria.

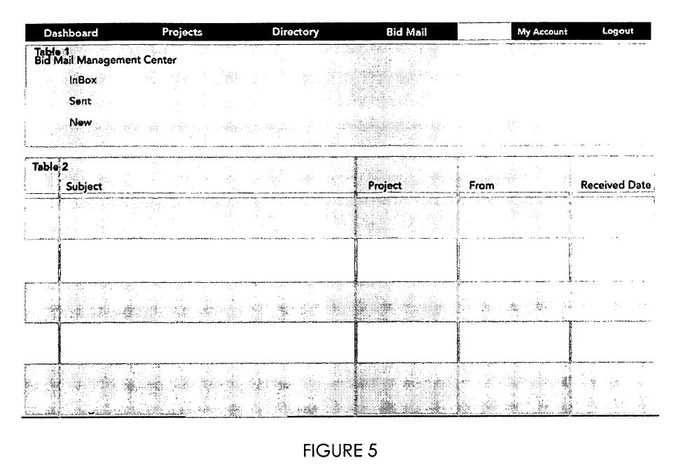

FIG. 5 is a screen shot of a Bid Mail—Buyer Webpage of a specific exemplary embodiment of the present invention. The object of Bid Mail is for Buyers and Suppliers to have a portal communication center separate from their general email account programs.

A buyer can view the following:

Inbox—View any supplier project questions that were sent to the buyer.

Sent—view the history of emails sent to various supplier groups.

New—Allows the buyer to send a message to an individual supplier or to a selected group. The buyer selects the new button, then a new screen appears for the buyer to select the project name, upload any files that are relevant to the email that needs to be dispersed, and can select to have an email sent to the following supplier groups:
“Accepted Bid Suppliers”,
“Declined Bid Suppliers”,
“Viewing Suppliers”, and
“No Response Suppliers”.

Further, the Buyer can select an option that sends them to another pop up window to select “All” or to select individual recipients. Once the Buyer has selected the recipients or the response groups, then the Bid Mail screen populates either the group name in the recipient's box, or, if individual recipients were selected, it will list all selected recipients, similar to MS Outlook.

The box on the right denotes a virtual paperclip to note that there are files attached to each email. If a buyer selects a message that was either received or sent, then it opens up another screen that presents the full email message and attached files. The buyer has the option to either delete the message or to reply to the message.

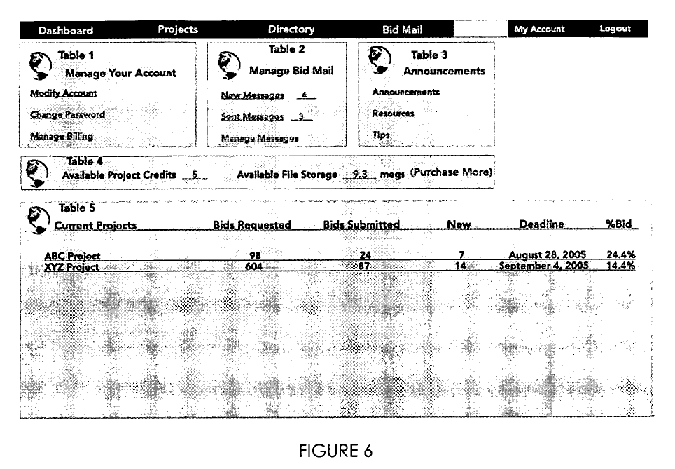

FIG. 6 is a screen shot of a My Account—Buyer Webpage of a specific exemplary embodiment of the present invention. Each location has the report table with an “edit” option below it. Once the edit button is selected it has a pop up window to edit that section of the table.

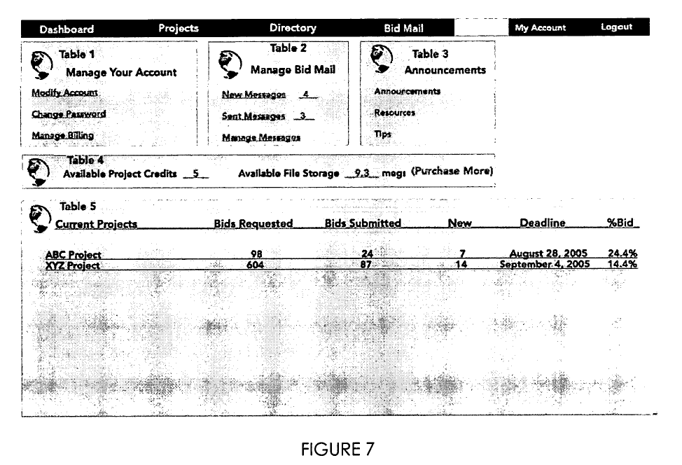

FIG. 7 is a screen shot of a Supplier Dashboard Webpage of a specific exemplary embodiment of the present invention.

Table 1—Manage Your Account.

Modify Account provides a link to the My Account page. Change Password provides a pop up window to change and verify a new password.

Table 2—Manage Bid Mail.

Table 2 allows the supplier to see new messages, previously sent messages, or to go to the general screen through Manage Messages. All go to the Bid Mail related sections.

Table 3—Announcements.

Announcements are general announcements pertaining to the bid management company. It is a link to a new page, e.g., /announcements.html. Resources provides a new page for general bid resource files. Tips displays a pop up window with general bid uploading file management tips, e.g., /tips.asp.

Table 4—Current Projects.

The current projects tab links to the database and lets the Supplier know how many projects they have bid on.

Table 5—Projects.

Projects is linked to the database which shows all Supplier projects and their current status. Each project has a link to the project page for the project selected in the list. The Supplier can select other projects in the same project screen to which they were redirected. Individual projects have a scroll over color change function so that the supplier knows what project they are selecting.

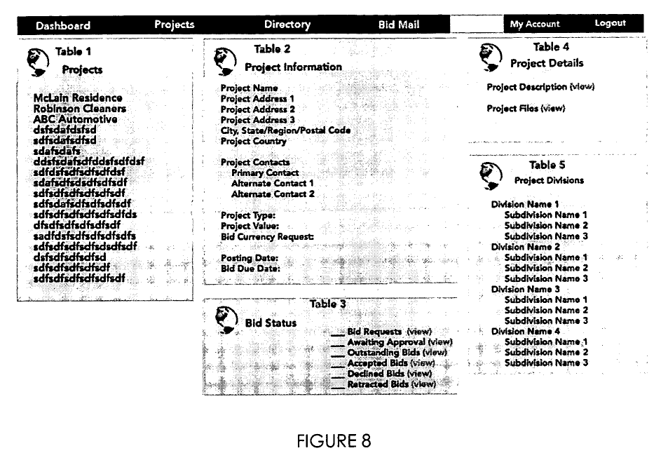

FIG. 8 is a screen shot of a Supplier Projects Webpage of a specific exemplary embodiment of the present invention. The page is broken down into five reporting tables:
Table 1—Project List
Table 2—Project Information
Table 3—Project Bid Status
Table 4—Project Details
Table 5—Project Divisions
Table 1—Project List

The project list is an expanding box vertically that lists all projects that the Supplier currently has open in the program. Preferably the list reports the project names in alphabetically order and accommodates long project names.

The Supplier can click on any of the project names and then to the right, the project tables 2-5 appear with the relevant information. As they scroll over the project names, the color of the name changes to the selected project.

Table 2—Project Information

The project information table provides all reporting information for the relevant project:
Project Name
Project Address 1
Project Address 2
Project Address 3
City, State/Region, Postal Code
Country
Primary Contact
Email address (hyper link into bid mail center)
Alternate Contact 1
Email address (hyper link into bid mail center)
Alternate Contact 2
Email address (hyper link into bid mail center)
Project Type
Project Posting Date
Project Bid Due Date
Estimated Value

Table 3—Project Bid Status.

Table 3 provides the current numbers of each type of bid status:
Requested Bids
Awaiting Approval
Outstanding
Accepted
Declined
Retracted

Each bid status has a “view” button to the side that creates a pop up window to view the referenced list.

Table 4—Project Details.

Table 4 has two components:

Project Description displays a pop up window that shows the project description box.

Project Files displays a pop up window that shows the current project files.

Table 5—Project Divisions/Subdivisions.

Table 5 shows all selected divisions for the project.

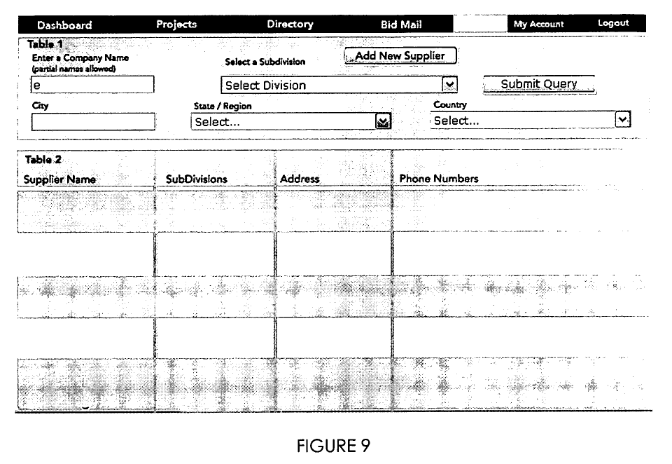

FIG. 9 is a screen shot of a Supplier Directory Webpage of a specific exemplary embodiment of the present invention. The Supplier Directory allows for Suppliers to search for their current Buyer list by searching based upon the criteria of 1) Company Name; 2) Subdivision Handled; 3) City; 4) State/Region; and 5) Country.

Table 1—Query Search Based Upon Above Criteria.

Table 2—Query Search results. Once a Supplier has done a query search for the buyers, it will populate the list below the query box. A white or tan box separates each supplier. The results list the supplier name, address, subdivision, and the phone numbers. The Supplier can click on any buyer and it will create a pop up window of the buyer's detail information.

The Buyer's Detail information includes:
Company name
Company Address
Company Address 2
Company Address 3
City, State/Region, Postal Code
Country
Contacts Primary, Alt. 1 and 2 with all email addresses that hyperlink to the Bid Mail Center
Phone Numbers
Company Website
Company Description Box
Company Certifications

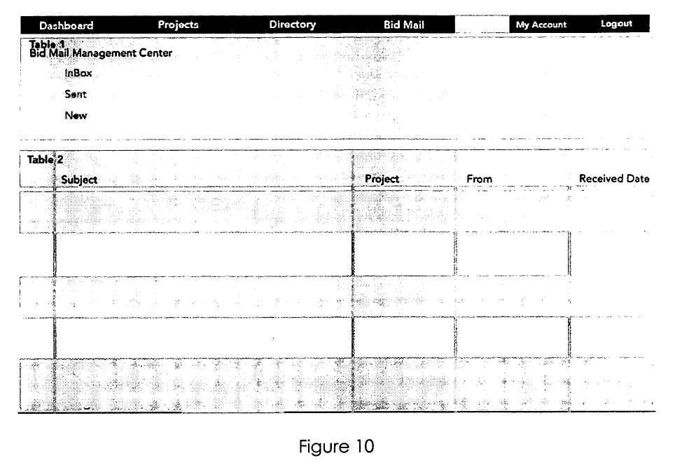

FIG. 10 is a screen shot of a Bid Mail—Supplier Webpage of a specific exemplary embodiment of the present invention. The object of Bid Mail is for Buyers and Suppliers to have a portal communication center separate from their general email account programs. A Supplier can view the following:

Inbox—View any buyer project answers or questions that were sent to the supplier.

Sent—view the history of emails sent to various buyer groups.

New—Allow the Supplier to send a message to an individual buyer or to a selected group.

The Supplier selects the new button, and then a new screen appears for the Supplier to select the project name, upload any files that are relevant to the email that need to be dispersed, can select to have an email sent to the following buyer groups: “Accepted Bid Buyers”, or “All Buyers.”

The Supplier can also select an option that sends them to another pop up window to select “All” or to select individual recipients. Once the Supplier has selected the recipients or the response groups, then the Bid Mail screen populates either the group name in the recipients box or if individual recipients that were selected, it will list all selected recipients, similar to MS Outlook®.

The box on the right as a paperclip to note that there are files attached to each email. If a Supplier selects a message that was either received or sent, another screen opens up that presents the full email message and attached files. The Supplier has the option to either delete the message or to reply to the message.

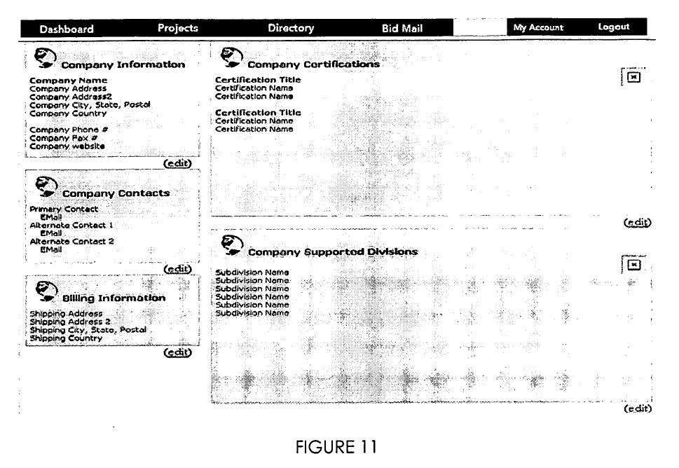

FIG. 11 is a screen shot of a My Account—Suppler Webpage of a specific exemplary embodiment of the present invention. Each location has the report table with an “edit” option below it. Once the edit button is selected it has a pop up window to edit that section table.

Accordingly, the present invention provides a system and method for managing an online invitation bid process between buyers and suppliers. In particular specific embodiments, the system or method is subscriber-based to the extent that buyer and suppliers subscribe to become participant members. Subscription benefits include, for example, security protocols to provide secure access to the system. Security protocols may include, for example, user names or IDs and passwords.

Bid invitations may be communicated by email, for example. Additionally, bid invitations may be directed to a specified email address independent of the supplier's Bid Mail account described above.

A system of the present invention may provide a World Wide Web URL for buyer and suppliers to access the system. The Web pages of the Web site may contain, for example, HTML content or content in any other suitable extensible mark-up language, including Perl. An advantage of using the Web for the present invention is that buyers and sellers are connected globally such that a buyer may invite and supplier may participate from anywhere on the globe with Web access. A further advantage of the present invention is that no proprietary computer software other than a Web browser is required for a buyer or seller to participate.

The invention is particularly suitable for construction project bid management so that a contractor is able to broadcast, essentially, the scope and specifications of a project worldwide for inspection by suppliers. The buyer is also able to inspect supplier information and to invite select suppliers to bid. In certain specific embodiments, suppliers are categorized according to the goods or services they provide to facilitate efficient inspection by buyers. The suppliers may self-identify the category or categories to which they belong.

Other markets where the present invention finds utility include RFPs and RFQs for government and military contracts, technology bid projects, entertainment and event services, food services, financial services, and manufacturing.

The present invention differs from e-commerce open bid websites, such as, for example, Ebay®, by virtue of, among other things, providing private bidding where only the buyer knows the particulars of a submitted bid. Ebay®, in contrast, publicly posts the high bid so that a prospective bidder knows how much to bid to win. The present invention, nevertheless, is adaptable to e-commerce solutions for the purchase or sale of selected discreet goods or services. Additionally, the present invention contemplates low-bid embodiments, such as, for example, publishing the current low bid so that later bidders have a target price to aim for. The invention also contemplates embodiments having an open bid procedure.

The present invention further contemplates a computer readable medium (“CRM”) containing computer-executable programming instructions for the present invention to operate on a computer. CRM includes any kind of computer memory such as floppy disks, conventional hard disks, CD-ROMs, Flash ROMS, nonvolatile ROM, RAM, storage media, and signals containing instructions.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

I claim:

1. A system for managing an online invitation bid process between buyers and suppliers, the system comprising:
a Website that provides one or more Web pages containing buyer and supplier information for inspection;
means to invite one or more supplier to bid;
means for the buyer to receive invited bids; and
means for a buyer and a supplier to update information online to one or more Webpage.

2. The system of claim 1, wherein the system is subscriber-based.

3. The system of claim 2, further comprising subscriber security, whereby subscriber buyers and subscriber suppliers access the Web site securely.

4. The system of claim 1, further comprising a homepage URL through which a buyer or a supplier accesses a system Webpage.

5. The system of claim 1, further comprising email.

6. The system of claim 1, wherein the system manages construction project bids.

7. The system of claim 1, wherein the system manages bids for a government contract.

8. The system of claim 1, wherein a bid process is managed without paper.

9. The system of claim 1, further comprising an e-commerce feature for purchasing one or more project item.

10. The system of claim 1, wherein the system manages a bid process for services.

11. The system of claim 1, wherein the system manages a bid process for goods.

12. The system of claim 1, wherein the system manages a bid process for goods and services.

13. The system of claim 1, wherein the Web pages further comprise:
a user dashboard Web page;
a user projects Web page;
a directory Web page;
a bid mail Web page; and
an account Web page.

14. The system of claim 13, further comprising a logout Web page.

15. The system of claim 1, wherein the Web pages comprise HTML content.

16. A method for managing an online invitation bid process between buyers and suppliers, the method comprising:
accessing a Website that contains buyer and supplier information on one or more Webpage;
inspecting a Web page of the Website;
inviting a supplier to bid;
submitting a bid in response to a bid invitation;
receiving a bid; and
selecting a bid winner.

17. The method of claim 16, further comprising updating information online to one or more Webpage;

18. The method of claim 16, wherein inviting a supplier to bid further comprises emailing the invitation to the supplier.

19. The method of claim 16, wherein the method manages a construction project bid process.

20. A computer readable medium containing instructions for a computer to manage an online invitation bid process between buyers and suppliers.
